(19) United States
(12) Patent Application Publication
(10) Pub. No.: US 2018/0005300 A1
(43) Pub. Date: Jan. 4, 2018

(54) INFORMATION PRESENTATION DEVICE, INFORMATION PRESENTATION METHOD, AND COMPUTER PROGRAM PRODUCT

(71) Applicants: KABUSHIKI KAISHA TOSHIBA, Tokyo (JP); TOSHIBA DIGITAL SOLUTIONS CORPORATION, Kawasaki-shi (JP)

(72) Inventor: Shinichiro Hamada, Yokohama Kanagawa (JP)

(21) Appl. No.: 15/702,971

(22) Filed: Sep. 13, 2017

Related U.S. Application Data
(63) Continuation of application No. PCT/JP2015/063532, filed on May 11, 2015.

(51) Int. Cl. G06Q 30/06; G06F 17/30

(52) U.S. Cl. CPC G06Q 30/0631; G06F 17/30867; G06F 17/30011; G06F 17/3053

(57) ABSTRACT

According to an embodiment, an information presentation device is configured to subtract a first score indicating a relation with a first product and a second score indicating a relation with a second product from a third score indicating a relation with both the first product and the second product, to calculate a total score for each word included in a third group of documents relating to both the first product and the second product, extracted from a group of documents to be searched, and present at least one of one or more important words that are selected according to a predetermined criterion based on the total score, and one or more pieces of text including important words in the third group of documents, as a recommendation reason including information on a combined effect of the first product and the second product.

### CROSS-REFERENCE TO RELATED APPLICATIONS

The present application is a continuation application of International Application No. PCT/JP2015/063532, filed May 11, 2015, the entire contents of which are incorporated herein by reference.

### FIELD

Embodiments described herein relate generally to an information presentation device, an information presentation method, and a computer program product.

### BACKGROUND

Many electronic commerce (EC) services that provide services of the EC include a product recommendation function for presenting a product relating to a certain product, when a user is referring to the certain product. The product recommendation function can be broadly classified into an opposing recommendation and a collaborative recommendation. In the opposing recommendation, a user is presented with a product similar to the product that the user is referring to (hereinafter, referred to as a “first product”), as an optional product to purchase. In the collaborative recommendation, another product (hereinafter, referred to as a “second product”) that goes well with the first product is presented to the user, and the user is urged to make what is called an “impulse buy”. The collaborative recommendation often has a mechanism of presenting a product highly correlated with the first product as the second product, from a statistical viewpoint. A conventional example is described in Japanese Patent Application Laid-open No. 2006-190127.

In the collaborative recommendation, it is important that the user recognizes the combined effect of the first product and the second product. In other words, if the second product is simply presented with the first product when the user is not recognizing the combined effect of the first product and the second product, the user will not be motivated to “impulse buy” the second product. For example, when a “potato” is presented together with “miso” to a user who does not know a “miso-potato” that has become famous as B-grade cuisine (cheap but tasty local food) in Chichibu, the user will only feel that the “potato” and the “miso” are a strange combination of food, and will not be motivated to buy the “potato” together with the “miso”. Consequently, when the second product is to be presented, it is effective to present a recommendation reason including information on the combined effect of the first product and the second product, so as to improve the sales promotion effects by the collaborative recommendation.

However, although the conventional EC system has a mechanism of presenting a recommendation reason relating to a single product (such as a review display function), the conventional EC system has no mechanism of presenting a recommendation reason including information on the combined effect of a plurality of products. Thus, a mechanism of presenting a recommendation reason including information on the combined effect such as the above is in demand.

### BRIEF DESCRIPTION OF THE DRAWINGS

FIG. 1 is a diagram illustrating a configuration example of an information presentation device of a first embodiment;

FIG. 2 is a flow chart illustrating a processing procedure of an A document group extraction unit;

FIG. 3 is a diagram illustrating an example of a thesaurus used for normalizing the expression of a word;

FIG. 4 is a flow chart illustrating a processing procedure of a whole document group extraction unit;

FIG. 5 is a flow chart illustrating a processing procedure of a word relation degree evaluation unit;

FIG. 6 is a flow chart illustrating a processing procedure of a word importance degree evaluation unit;

FIG. 7 is a flow chart illustrating a processing procedure of a total score calculation unit;

FIG. 8 is a flow chart illustrating a processing procedure of a unique sentence output unit;

FIG. 9 is a diagram illustrating a configuration example of an information presentation device of a second embodiment;

FIG. 10 is a flow chart illustrating a processing procedure of the A document group extraction unit;

FIG. 11 is a flow chart illustrating a processing procedure of an A∩B document group extraction unit;

FIG. 12 is a diagram for explaining a determination example of the A∩B document group extraction unit;

FIG. 13 is a flow chart illustrating a processing procedure of the word relation degree evaluation unit; and

FIG. 14 is a block diagram illustrating an example of a hardware configuration of the information presentation device.

### DETAILED DESCRIPTION

According to an embodiment, an information presentation device presents a recommendation reason including information on a combined effect of a first product and a second product, when recommending the second product that goes well with the first product a user is referring to. The device includes a first score calculation unit, a second score calculation unit, a third score calculation unit, a total score calculation unit, and a presentation unit. The first score calculation unit is configured to extract a first group of documents relating to the first product from a group of documents to be searched, and calculate a first score indicating a relation with the first product, for each word included in the first group of documents. The second score calculation unit is configured to extract a second group of documents relating to the second product from the group of documents to be searched, and calculate a second score indicating a relation with the second product, for each word included in the second group of documents. The third score calculation unit is configured to extract a third group of documents relating to both the first product and the second product from the group of documents to be searched, and calculate a third score indicating a relation with both the first product and the second product, for each word included in the third group of documents. The total score calculation unit configured to subtract the first score and the second score from the third score, to calculate a total score for each word included in the third group of documents. The presentation unit is configured to present at least one of one or more important words that are selected according to a predetermined criterion based on the total score, and one or more pieces of text including important words in the third group of documents, as the recommendation reason.

Hereinafter, an information presentation device, an information presentation method, and a computer program product of embodiments will be described in detail with reference to the accompanying drawings.

An information presentation device of the embodiments presents a recommendation reason including information on a combined effect of a first product and a second product, in recommending the second product that goes well with the first product a user is referring to. It is difficult to manually create such a recommendation reason in advance for each and every combination of products. However, information on the combined effect of products is present in a document group such as various types of Web pages, social networking services (SNSes), and blogs. The present embodiment finds out a group of documents on both products from the document group such as the above, and specifies and presents a suitably referred portion to a user as the recommendation reason of the combined effect of the products and the like. To simplify the following explanation, the first product is referred to as a product A, a document including a description on the first product is referred to as an A document, the second product is referred to as a product B, a document including a description on the second product is referred to as a B document, and a document including a description on both the first product and the second product is referred to as a A∩B (both A and B) document.

### First Embodiment

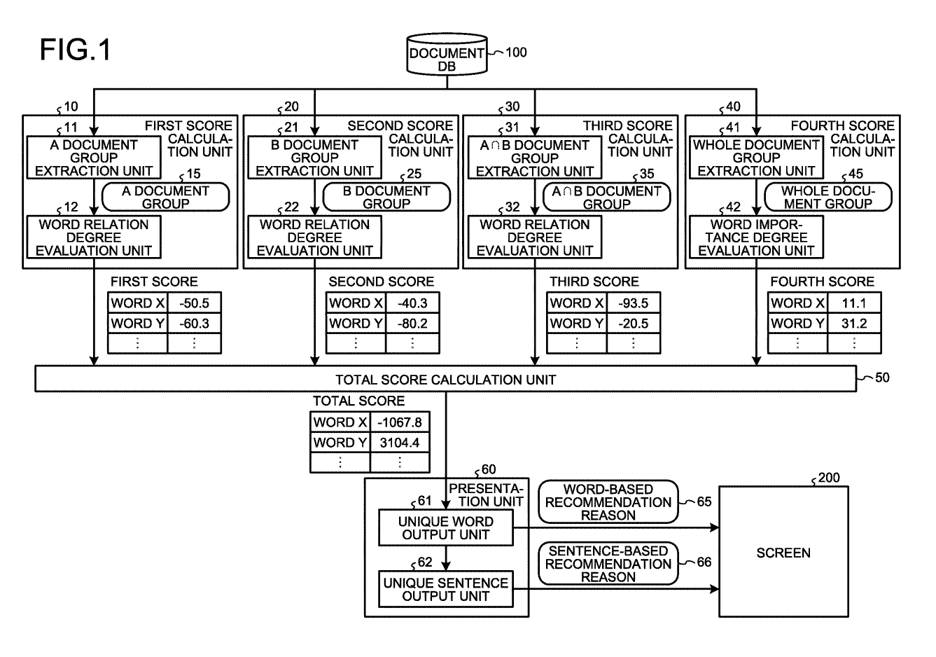

First, an information presentation device of a first embodiment will be described. FIG. 1 is a diagram illustrating a configuration example of the information presentation device of the first embodiment. As illustrated in FIG. 1, the information presentation device of the present embodiment includes a first score calculation unit 10, a second score calculation unit 20, a third score calculation unit 30, a fourth score calculation unit 40, a total score calculation unit 50, and a presentation unit 60. The information presentation device of the present embodiment presents a recommendation reason including information on a combined effect of the first product and the second product obtained from a document database (DB) 100 to a user who is using the service of the EC system, by displaying the recommendation reason on a screen 200. Incidentally, the information processing device of the present embodiment is implemented as a part of functions of the EC system. However, it is not limited thereto, and the information processing device may be configured as an independent system or an independent device that is operated in conjunction with the EC system, for example.

The document DB 100 is any desired document group to be searched in the present embodiment, and may be various types of Web pages, SNSes, blogs, and the like. The screen 200 may be a screen to be displayed on a terminal device of the user who is using the service of the EC system. In general, the screen 200 is a Web screen displayed on the terminal device provided with a Web browser.

The first score calculation unit 10 includes an A document group extraction unit 11 and a word relation degree evaluation unit 12.

The A document group extraction unit 11 obtains an A document group 15 by performing a word-based search on the document DB 100, and extracting all A documents including a description on the product A from the document DB 100.

The word relation degree evaluation unit 12 creates a histogram (data listing the appearance frequency of each word) for each of words in the A document group 15, and calculates a first score corresponding to the appearance frequency of each of the words in the A document group 15. However, a dictionary is used to absorb orthographical variants of each word such as double-byte characters and single-byte characters, Japanese and English, and kana written after a kanji character. Moreover, the first score is obtained by normalizing the appearance frequency of each word, by dividing the appearance frequency of each word by the total number of words, and converting the value into a log scale. Consequently, the first score is a negative value, and a first score with a higher value closer to zero is given to the word as the appearance frequency in the A document group 15 is higher.

The second score calculation unit 20 includes a B document group extraction unit 21 and a word relation degree evaluation unit 22.

The B document group extraction unit 21 obtains a B document group 25 by performing a word-based search on the document DB 100, and extracting all B documents including a description on the product B from the document DB 100.

The word relation degree evaluation unit 22 creates a histogram for each of words in the B document group 25, and calculates a second score corresponding to the appearance frequency of each of the words in the B document group 25. However, a dictionary is used to absorb orthographical variants of each word such as double-byte characters and single-byte characters, Japanese and English, and kana written after a kanji character. Moreover, the second score is obtained by normalizing the appearance frequency of each word, by dividing the appearance frequency of each word by the total number of words, and converting the value into a log scale. Consequently, the second score is a negative value and a second score with a higher value closer to zero is given to the word as the appearance frequency in the B document group 25 is higher.

The third score calculation unit 30 includes an A∩B document group extraction unit 31 and a word relation degree evaluation unit 32.

The A∩B document group extraction unit 31 performs a word-based search on the document DB 100, and obtains an A∩B document group 35 by extracting all the A∩B documents including a description on both the product A and the product B from the document DB 100.

The word relation degree evaluation unit 32 creates a histogram for each of words in the A∩B document group 35, and calculates a third score corresponding to the appearance frequency of each of the words in the A∩B document group 35. However, a dictionary is used to absorb orthographical variants of each word such as double-byte characters and single-byte characters, Japanese and English, and kana written after a kanji character. Moreover, the third score is obtained by normalizing the appearance frequency of each word, by dividing the appearance frequency by the total number of words, and converting the value into a log scale. Consequently, the third score is a negative value, and a third score with a higher value closer to zero is given to the word as the appearance frequency in the A∩B document group is higher.

The fourth score calculation unit 40 includes a whole document group extraction unit 41 and a word importance degree evaluation unit 42.

The whole document group extraction unit 41 obtains a whole document group 45 by extracting all the documents from the document DB 100.

The word importance degree evaluation unit 42 creates a histogram for the number of documents including words in the whole document group 45, and calculates a fourth score corresponding to the appearance frequency of the document including the word in the whole document group 45, for each of the words. However, a dictionary is used to absorb orthographical variants of each word such as double-byte characters and single-byte characters, Japanese and English, and kana written after a kanji character. Moreover, the fourth score is obtained by normalizing the appearance frequency of the document including words, by dividing the appearance frequency of the document including words by the total number of documents, converting the value into a log scale, and reversing the positive and negative. Consequently, the fourth score is a positive value and a fourth score with a higher value is given to the document including the word as the appearance frequency is lower.

The total score calculation unit 50 calculates the total score of each of the words included in the A∩B document group 35, using the third score, the first score, the second score, and the fourth score, using the following formula (1). The total score is an index indicating the uniqueness of each of the words relative to the topic relating to both the product A and the product B, and a total score with a higher value is given to the word as the uniqueness to the topic relating to both the product A and the product B is higher.

The presentation unit 60 includes a unique word output unit 61 and a unique sentence output unit 62.

The unique word output unit 61 selects one or more important words (unique words) with higher uniqueness to the topic relating to both the product A and the product B, based on the total score, and outputs the one or more important words to the screen 200 as a word-based recommendation reason 65. When the recommendation reason only needs to be a word, the word-based recommendation reason 65 output by the unique word output unit 61 is displayed on the screen 200.

The unique sentence output unit 62 selects a sentence or more with many important words (unique words) selected by the unique word output unit 61 from the A∩B document group 35, and outputs the sentence or more to the screen 200 as a sentence-based recommendation reason 66. When the recommendation reason needs to be a sentence, the sentence-based recommendation reason 66 output from the unique sentence output unit 62 is displayed on the screen 200. The word-based recommendation reason 65 output from the unique word output unit 61 and the sentence-based recommendation reason 66 output from the unique sentence output unit 62 may be both displayed on the screen 200.

In the present embodiment, the processing unit of the unique sentence output unit 62 is a sentence. However, the processing unit of the unique sentence output unit 62 may also be a phrase, a passage, a paragraph, and the like, instead of the sentence. In this case also, desirable text may be displayed on the screen 200 as a recommendation reason using the similar processes, except that the processing unit of the unique sentence output unit 62 is changed.

Next, details of the processing procedures by the units described above that configure the information presentation device of the present embodiment will be described.

First, a processing procedure of the A document group extraction unit 11 will be described. The object of the process of the A document group extraction unit 11 is to find out all the A documents from the document DB 100. For example, the A document can be extracted by performing the word-based search using a conventional method. A general searching process generally uses a processing method of creating an index of a document group to be searched in advance. However, to simplify the explanation, a grep method that performs searching without creating an index, is used in the present embodiment.

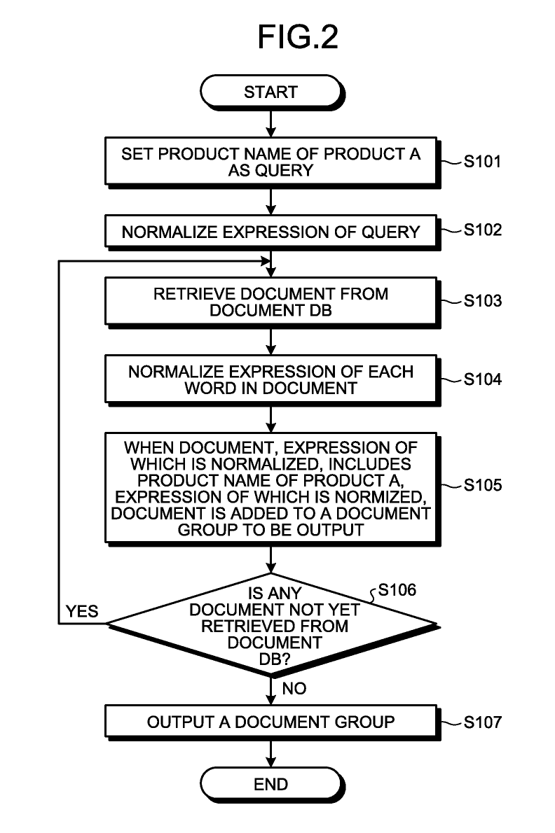

FIG. 2 is a flow chart illustrating a processing procedure of the A document group extraction unit 11. First, the A document group extraction unit 11 retrieves a product name from metadata relating to a product A, and sets the product name as a query to search (step S101).

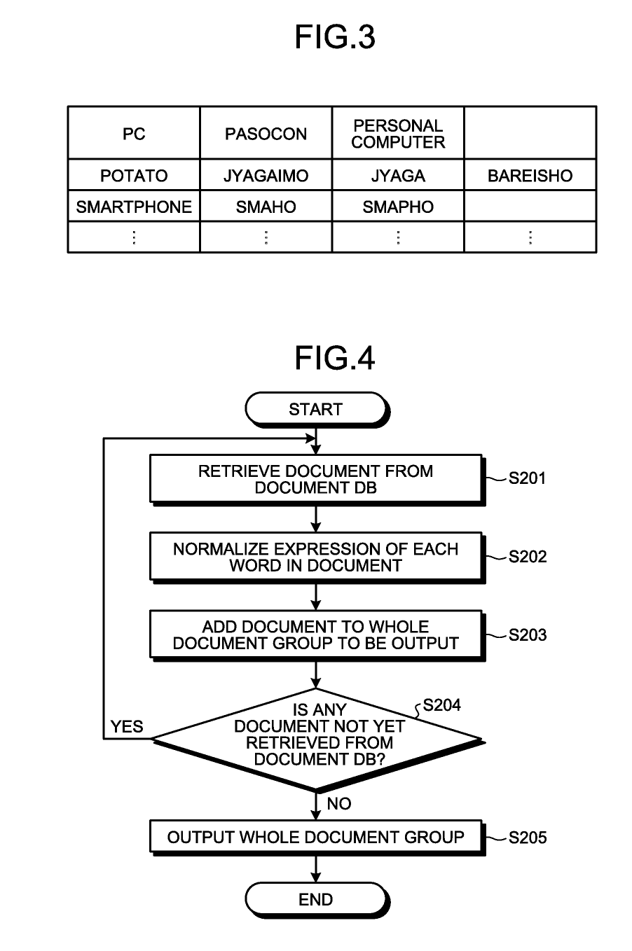

Next, the A document group extraction unit 11 normalizes the expression of the query (step S102). More specifically, by using the thesaurus illustrated in FIG. 3, the A document group extraction unit 11 first absorbs orthographical variants (such as double-byte characters and single-byte characters, Japanese and English, and kana written after a kanji character) of the query, replaces the query (in this example, the product name of the product A) with a typical expression. For example, the query of “smaho” is replaced with “smartphone”, and the query of “pasocon” is replaced with “PC”.

Next, the A document group extraction unit 11 retrieves a document from the document DB 100 (step S103). The A document group extraction unit 11 then normalizes the expression of the words included in the document retrieved at step S103, by performing the same process as that at step S102 (step S104).

Next, the A document group extraction unit 11 determines whether the document that includes words, the expression of which is normalized at step S104, includes the query (in other words, the product name of the product A) the expression of which is normalized at step S102. When the query, the expression of which is normalized, is included in the document, the A document group extraction unit 11 adds the document to the A document group 15 to be output (step S105).

Next, the A document group extraction unit 11 determines whether there is any document not yet retrieved from the document DB 100 (step S106), and if there is a document not yet retrieved from the document DB 100 (Yes at step S106), the A document group extraction unit 11 returns the process to step S103, and repeats the following processes. When the processes from step S103 to step S105 are carried out on all the documents in the document DB 100 (No at step S106), the A document group extraction unit 11 outputs the A document group 15 (step S107), and finishes the series of processes.

The object of the process of the B document group extraction unit 21 is to find out all the B documents from the document DB 100. Similar to extracting the A document, the B document is extracted using a word-based search. The process of the B document group extraction unit 21 is the same as the process of the A document group extraction unit 11 described above, except that the query used for searching is replaced with the product name of the product B, and the document group to be output is replaced with the B document group 25. Thus, the detailed description thereof will be omitted.

The object of the process of the A∩B document group extraction unit 31 is to find out all the A∩B documents from the document DB 100. Similar to extracting the A document or the B document, the A∩B document can be extracted by performing the word-based search. The process of the A∩B document group extraction unit 31 is the same as the process of the A document group extraction unit 11 or the process of the B document group extraction unit 21 described above, except that the query used for searching is the product name of both the product A and the product name of the product B, and the document group to be output is replaced with the A∩B document group 35. Thus, the detailed description thereof will be omitted.

The object of the process of the whole document group extraction unit 41 is to retrieve all the documents from the document DB 100, and to normalize the expression of the words included in each of the documents for the subsequent processes.

FIG. 4 is a flow chart illustrating a processing procedure of the whole document group extraction unit 41. First, the whole document group extraction unit 41 retrieves a document from the document DB 100 (step S201). The whole document group extraction unit 41 then normalizes the expression of the words included in the document retrieved at step S201, by performing the same process as that at step S102 in FIG. 2 (step S202), and adds the document to the whole document group 45 to be output (step S203).

Next, the whole document group extraction unit 41 determines whether there is any document not yet retrieved from the document DB 100 (step S204). When there is a document not yet retrieved from the document DB 100 (Yes at step S204), the whole document group extraction unit 41 returns the process to step S201 and repeats the following processes. On the other hand, when the processes from step S201 to S203 are carried out on all the documents in the document DB 100 (No at step S204), the whole document group extraction unit 41 outputs the whole document group 45 (step S205), and finishes the series of processes.

Next, a processing procedure of the word relation degree evaluation unit 12 will be described. The object of the process of the word relation degree evaluation unit 12 is to calculate the first score indicating a relation with the product A, for each of the words included in the A document group 15. In the present embodiment, the first score is obtained by calculating a log probability of each of the words by dividing the appearance frequency of each of the words in the A document group 15 by the total number of words, and converting it into a log scale. In other word, the first score is obtained by measuring the frequency of each of the words per unit text amount, and is equivalent to a value obtained by normalizing term frequency (tf) that is an index often used in information retrieval.

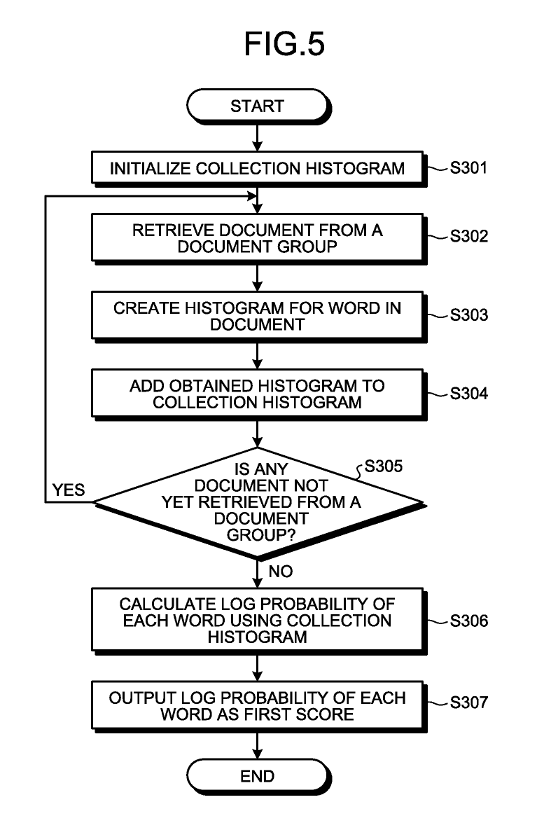

FIG. 5 is a flow chart illustrating a processing procedure of the word relation degree evaluation unit 12. First, the word relation degree evaluation unit 12 initializes a collection histogram for collecting the appearance frequency of each of the words (step S301).

Next, the word relation degree evaluation unit 12 retrieves a document from the A document group 15 (step S302). The word relation degree evaluation unit 12 then creates a histogram for words included in the document retrieved at step S302 (step S303), and adds the obtained histogram to the collection histogram (step S304).

Next, the word relation degree evaluation unit 12 determines whether there is any document not yet retrieved from the A document group 15 (step S305). When there is a document not yet retrieved from the A document group 15 (Yes at step S305), the word relation degree evaluation unit 12 returns the process to step S302 and repeats the following processes. When the processes from step S302 to step S304 are performed on all the documents in the A document group 15 (No at step S305), the word relation degree evaluation unit 12 calculates the log probability of each of the words using the collection histogram (step S306). More specifically, when the appearance frequency of each of the words indicated in the collection histogram is x, and the total number of words in the A document group 15 is y, the log probability is log(x/y). The word relation degree evaluation unit 12 then outputs the log probability of each of the words calculated at step S306 as the first score of each of the words (step S307), and finishes the series of processes. When x=0, the log probability is −∞. Because a calculator cannot directly handle ∞ or −∞, a method of substituting ∞ or −∞ with an extremely large value or an extremely small value may be used. The same method may also be used in the following, when ∞ or −∞ is to be used.

The object of the process of the word relation degree evaluation unit 22 is to calculate the second score indicating a relation with the product B, for each of the words included in the B document group 25. Similar to the first score, the second score is a log probability of each of the words included in the B document group 25. The process of the word relation degree evaluation unit 22 is the same as the process of the word relation degree evaluation unit 12 described above, except that the document set to be given is replaced with the B document group 25, and the log probability of each of the words included in the B document group 25 is output as the second score. Thus, the detailed description thereof will be omitted.

The object of the process of the word relation degree evaluation unit 32 is to calculate the third score indicating a relation with both the product A and the product B, for each of the words included in the A∩B document group 35. Similar to the first score and the second score, the third score is a log probability of each of the words included in the A∩B document group 35. The process of the word relation degree evaluation unit 32 is the same as the process of the word relation degree evaluation unit 12 described above, except that the document set to be given is replaced with the A∩B document group 35, and the log probability of each of the words included in the A∩B document group 35 is output as the third score. Thus, the detailed description thereof will be omitted.

Next, a processing procedure of the word importance degree evaluation unit 42 will be described. The object of the process of the word importance degree evaluation unit 42 is to calculate the fourth score indicating the general importance of each of the words in the document DB 100. In the present embodiment, the fourth score of each word is obtained by calculating inverse document frequency (idf) that is often used in information retrieval, as an index of the importance of a word. The idf of a certain word is a negative log probability of the document including the word. In other words, when the number of documents including the word is x and the total number of documents is y, idf=−log(x/y). In general, a word that does not appear often (in other words, a word with a low appearance probability) is considered as an important word because large amount of information is given to the reader when the word has appeared. In this case, the idf has a high value.

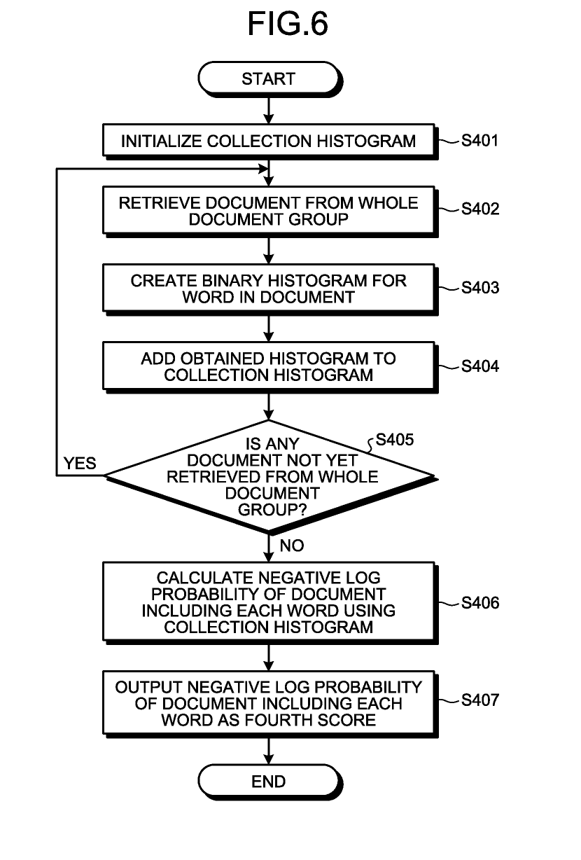

FIG. 6 is a flow chart illustrating a processing procedure of the word importance degree evaluation unit 42. First, the word importance degree evaluation unit 42 initializes the collection histogram for collecting the appearance frequency of each of the words (step S401).

Next, the word importance degree evaluation unit 42 retrieves a document from the whole document group 45 (step S402). The word importance degree evaluation unit 42 then creates a binary histogram for a word included in the document retrieved at step S402 (step S403), and adds the obtained histogram to the collection histogram (step S404). The binary histogram is a histogram that only has a frequency value of 1 or 0, and 1 is applied to the word that appears in the document regardless of the appearance frequency.

Next, the word importance degree evaluation unit 42 determines whether there is any document not yet retrieved from the whole document group 45 (step S405). When there is a document not yet retrieved from the whole document group 45 (Yes at step S405), the word importance degree evaluation unit 42 returns the process to step S402 and repeats the following processes. On the other hand, when the processes from step S402 to step S404 are performed on all the documents in the whole document group 45 (No at step S405), the word importance degree evaluation unit 42 calculates a negative log probability of the document including words using the collection histogram (step S406). More specifically, when the appearance frequency of each of the words indicated in the collection histogram is x, and the total number of documents in the whole document group 45 is y, the negative log probability is −log(x/y). The word importance degree evaluation unit 42 then outputs the negative log probability of the document including the word calculated at step S406, as the fourth score of the word, for each of the words (step S407), and finishes the series of processes.

Next, a processing procedure of the total score calculation unit 50 will be described. The object of the process of the total score calculation unit 50 is to calculate the total score that is an index indicating the uniqueness of each of the words relative to both the topic relating to the product A and the product B (in other words, a degree whether the word only appears significantly in the A∩B document group 35), for each of the words in the in the A∩B document group 35. Consequently, it is possible to find a word suitable for explaining the combination of the product A and the product B.

In the present embodiment, the following formula (1) is used to calculate the total score. In the following formula (1), w is a word, ntf(w) is a log probability of the word w in a given document set, and idf is a negative log probability of a document including the word w in the whole document group 45.

[Formula 1]

(ntf_{A∩B}(w)·2−ntf_{A}(w)−ntf_{B}(w))*idf(w) (1)

The first term of the formula (1) indicates the log probability of the word w in the A∩B document group 35, and corresponds to the third score output by the word relation degree evaluation unit 32. the higher value of the first term (third score) indicates that the word w appears more often in the A∩B document group 35.

The second term of the formula (1) indicates the log probability of the word w in the A document group 15, and corresponds to the first score output by the word relation degree evaluation unit 12. The higher value of the second term (first score) indicates that the word w appears more often in the A document group 15.

The third term of the formula (1) indicates the log probability of the word w in the B document group 25, and corresponds to the second score output by the word relation degree evaluation unit 22. The higher value of the third term (second score) indicates that the word w appears more often in the B document group 25.

The fourth term of the formula (1) indicates the rareness of the word w in the whole document group 45, and corresponds to the fourth score output by the word importance degree evaluation unit 42. The higher value of the fourth term (fourth score) indicates that the word w is rare and is a more important word with the larger amount of information when the word w has appeared.

The formula (1) is an equation for calculating the total score by subtracting the second term and the third term from the first term. Consequently, a total score with a higher value is given to the word that appears often in the A∩B document group 35, but does not appear often in the A document group 15 or in the B document group 25. Thus, the total score indicates a degree suitable for explaining both products, but not a degree suitable for explaining the product A or the product B individually. The first term is multiplied by two, because two terms are subtracted from the first term. The uniqueness of the word that appears at the same frequency in the A∩B document group 35, the A document group 15, and the B document group 25 is possibly zero. However, by multiplying the first term by two as illustrated in the formula (1), the total score becomes zero. There is no need to multiply the first term by two, and the second term and the third term may be subtracted from the first term without multiplying the first term by two.

Moreover, the formula (1) is the equation for calculating the total score by multiplying the value obtained by subtracting the second term and the third term from the first term, by the fourth term. Consequently, it is possible to obtain the total score added with the importance of each of the words in a general point of view. In other words, when the total score of each of the words is calculated without multiplying the fourth term, while the number of documents in the A document group 15, the number of documents in the B document group 25, and the number of documents in the A∩B document group 35 are not enough, there is a risk that the total score be overfitted. However, by multiplying the fourth score, it is possible to prevent the risk. There is no need to multiply by the fourth term, and the total score may be calculated without multiplying the fourth term.

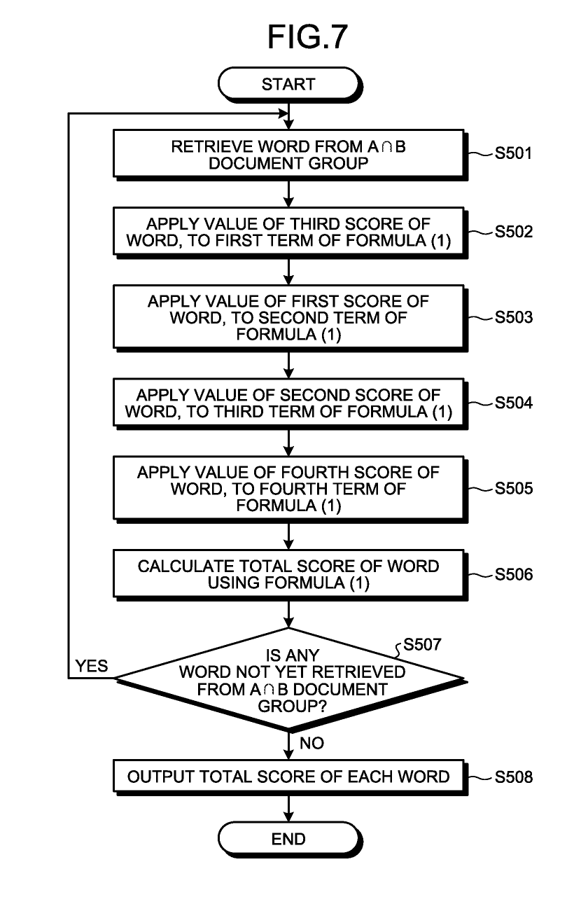

FIG. 7 is a flow chart illustrating a processing procedure of the total score calculation unit 50. First, the total score calculation unit 50 retrieves a word from the A∩B document group 35 (step S501).

Next, the total score calculation unit 50 applies the value of the third score output by the word relation degree evaluation unit 32, to the first term of the formula (1), for the word retrieved at step S501 (step S502).

Next, the total score calculation unit 50 applies the value of the first score output by the word relation degree evaluation unit 12 to the second term of the formula (1), for the word retrieved at step S501 (step S503).

Next, the total score calculation unit 50 applies the value of the second score output by the word relation degree evaluation unit 22 to the third term of the formula (1), for the word retrieved at step S501 (step S504).

Next, the total score calculation unit 50 applies the value of the fourth score output by the word importance degree evaluation unit 42 to the fourth term of the formula (1), for the word retrieved at step S501 (step S505).

Next, the total score calculation unit 50 calculates the total score of the word retrieved at step S501, using the formula (1)(step S506).

Next, the total score calculation unit 50 determines whether there is any word not yet retrieved from the A∩B document group 35 (step S507). When there is a word not yet retrieved from the A∩B document group 35 (Yes at step S507), the total score calculation unit 50 returns the process to step S501 and repeats the following processes. On the other hand, when the processes from step S501 to step S506 are performed on all the words in the A∩B document group 35 (No at step S507), the total score calculation unit 50 outputs the total score of each of the words (step S508), and finishes the series of processes.

Next, a processing procedure of the unique word output unit 61 will be described. The object of the process of the unique word output unit 61 is to select a word (unique word) with higher uniqueness to the topic relating to both the product A and the product B, among the words included in the A∩B document group 35, as an important word for output. In the present embodiment, the top k pieces of words with higher total scores, among the words included in the A∩B document group 35, are output as the important words.

In other words, the unique word output unit 61 sorts the total scores output from the total score calculation unit 50 in the descending order of the values, and selects the top k pieces of the total scores in the descending order of the total scores with high values, as the important words for output. When the recommendation reason of the product B only needs to be a word, the important word output from the unique word output unit 61 is displayed on the screen 200 as the word-based recommendation reasons 65. When the recommendation reason needs to be a sentence, the important word output from the unique word output unit 61 is passed to the unique sentence output unit 62.

Next, a processing procedure of the unique sentence output unit 62 will be described. The object of the process of the unique sentence output unit 62 is to find out a sentence including many important words from the A∩B document group 35, and outputs the sentence on the screen 200 as the sentence-based recommendation reason 66. In the present embodiment, a sentence that includes the important words most in the A∩B document group 35 is to be found out as the best sentence, and the best sentence is displayed on the screen 200 as the sentence-based recommendation reason 66. As described above, a phrase, a passage, a paragraph, or the like may be displayed on the screen 200 as the recommendation reason, instead of the sentence.

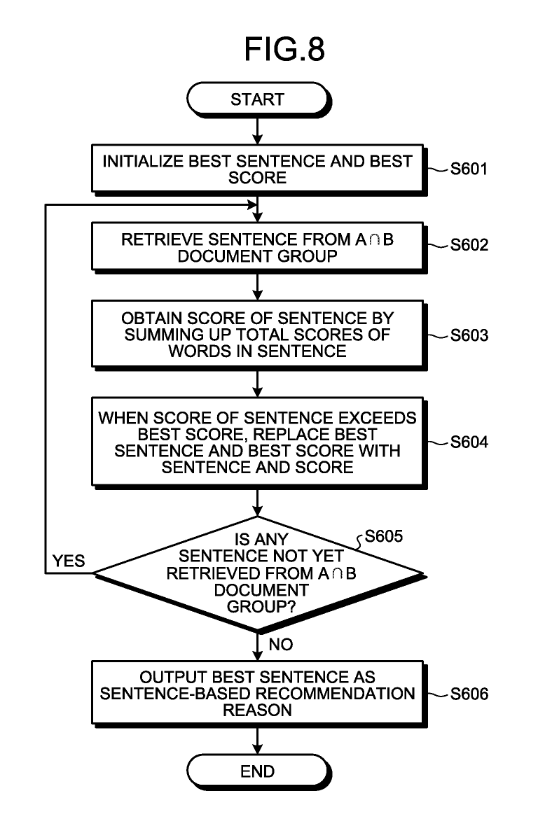

FIG. 8 is a flow chart illustrating a processing procedure of the unique sentence output unit 62. First, the unique sentence output unit 62 initializes the best sentence and the best score (step S601). In other words, the best sentence to be output as the sentence-based recommendation reason 66 in the end is set as an empty sentence, and the best score that is the total value of the total scores of the words included in the best sentence is set as −∞.

Next, the unique sentence output unit 62 retrieves a sentence from the A∩B document group 35 (step S602). The unique sentence output unit 62 then sets a value obtained by summing up the total scores of the words included in the sentence retrieved at step S602 as the score of the sentence (step S603).

Next, the unique sentence output unit 62 determines whether the score of the sentence calculated at step S603 exceeds the best score. When the score of the sentence exceeds the best score, the unique sentence output unit 62 replaces the best sentence and the best score with the sentence and the score (step S604).

Next, the unique sentence output unit 62 determines whether there is any sentence not yet retrieved from the A∩B document group 35 (step S605). When there is a sentence not yet retrieved from the A∩B document group 35 (Yes at step S605), the unique sentence output unit 62 returns the process to step S602 and repeats the following processes. On the other hand, when the processes from step S602 to step S604 are performed on all the sentences included in the A∩B document group 35 (No at step S605), the unique sentence output unit 62 outputs the best sentence as the sentence-based recommendation reason 66 (step S606), and finishes the series of processes.

As described above using specific examples, the information presentation device of the present embodiment specifies a word with higher uniqueness to the topic relating to both the product A and the product B, or a sentence including the word; and displays the word or the sentence on the screen 200 as the word-based recommendation reason 65 or the sentence-based recommendation reason 66. Consequently, by using the information presentation device, it is possible to suitably present the recommendation reason including information on the combined effect of the product A and the product B to the user who is using the EC system, and improve the sales promotion effects by the collaborative recommendation. In other words, the user who is using the EC system is motivated to purchase the product B and can easily purchase the product accompanied by new experiences, by referring to the recommendation reason presented by the information presentation device of the present embodiment. Consequently, shops can increase sales opportunities.

### Second Embodiment

Next, an information presentation device of a second embodiment will be described. In the present embodiment, documents that are predicted to have a description on a certain product, such as review articles written by users who are using the EC system, are used as a document group to be searched. The EC system often manages review articles written by users for each product page. Such review articles are documents that contain impression on each of the products and the like. Consequently, each of the review articles can be effectively used as an object from which to find the recommendation reason. It is assumed that the review article is associated with a product ID to be reviewed (product identification information) and a purchase log of the user who has written the review article, as metadata. In the following, the review article associated with the product ID and the purchase log is referred to as a labeled document.

In the first embodiment, a general document is an object to be searched. Thus, the product name in the document is used as a key to search the A document, the B document, and the A∩B document. In the present embodiment, a product ID of a product to be reviewed (may also be a product name when the product name is associated with the review article) assigned to each document to be searched, is used as the key to search the A document, the B document, and the A∩B document. Consequently, it is possible to eliminate a document retrieval error (in the first embodiment, there is a risk of error such as an expression fluctuation). Moreover, even when a document does not include the product name such as “Yummy! I'll buy it again”, the document can be easily sorted using metadata. However, because only one product ID is assigned to the document, a certain effort is required to determine the A∩B document. Thus, in the present embodiment, the A∩B document is specified based on an assumption that the review article written by a user who has purchased the product A and the product B at close timings, at a timing close to when the user has purchased the products, most likely includes a reference on both products.

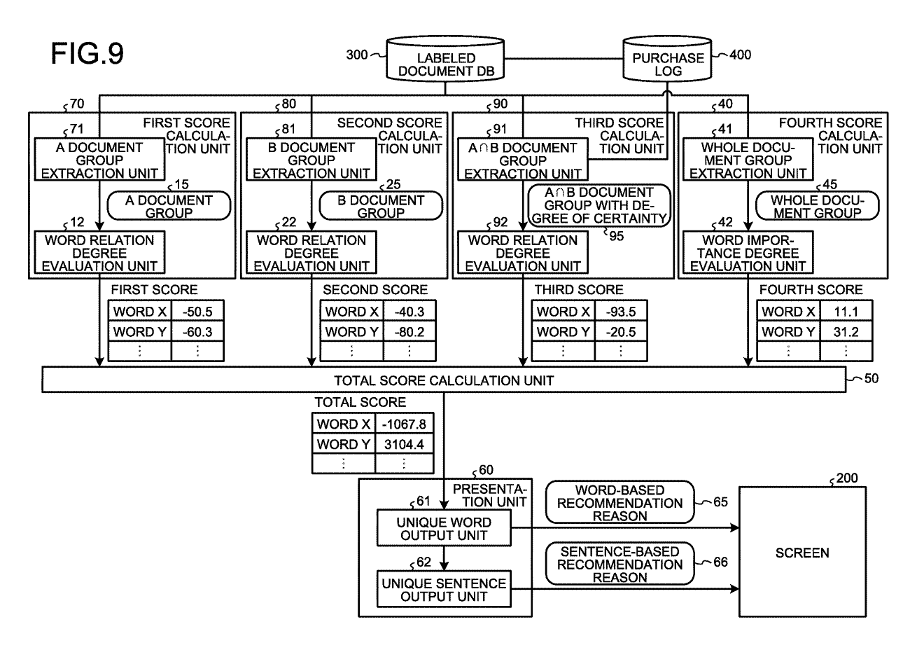

FIG. 9 is a diagram illustrating a configuration example of the information presentation device of the second embodiment. As illustrated in FIG. 9, the information presentation device of the second embodiment includes a first score calculation unit 70, a second score calculation unit 80, and a third score calculation unit 90 instead of the first score calculation unit 10, the second score calculation unit 20, and the third score calculation unit 30 (see FIG. 1) of the first embodiment. Moreover, the information presentation device of the second embodiment uses a labeled document DB 300 as a document set to be searched, instead of using the document DB 100 (see FIG. 1) of the first embodiment. As described above, for example, the labeled document DB 300 is a set of review articles written by the user who is using the EC system, and each of the review articles is associated with a product ID and a purchase log 400. The other components of the information presentation device of the second embodiment are the same as those of the first embodiment described above. Thus, the same reference numerals denote the same components as those in the first embodiment, and redundant explanations are appropriately omitted.

The first score calculation unit 70 includes an A document group extraction unit 71 and the word relation degree evaluation unit 12. The A document group extraction unit 71 searches the labeled document DB 300 using the product ID of the product A, and obtains the A document group 15 by extracting all the A documents from the labeled document DB 300. The word relation degree evaluation unit 12 is the same as that in the first embodiment.

The second score calculation unit 80 includes a B document group extraction unit 81 and the word relation degree evaluation unit 22. The B document group extraction unit 81 searches the labeled document DB 300 using the product ID of the product B, and obtains the B document group 25 by extracting all the B documents from the labeled document DB 300. The word relation degree evaluation unit 22 is the same as that in the first embodiment.

The third score calculation unit 90 includes an A∩B document group extraction unit 91 and a word relation degree evaluation unit 92.

The A∩B document group extraction unit 91 searches the labeled document DB 300 using both the product ID of the product A and the product ID of the product B, and obtains an A∩B document group with a degree of certainty 95 by extracting the A∩B document from the labeled document DB 300. In this example, the A∩B document to be extracted from the labeled document DB 300 is a labeled document such as a review article extracted on the basis of the assumption described above, and is applied with a degree of certainty that the document includes a description on both the product A and the product B.

Similar to the word relation degree evaluation unit 32 of the first embodiment, the word relation degree evaluation unit 92 calculates the third score of each of the words included in the A∩B document group with the degree of certainty 95, corresponding to the appearance frequency. However, the present embodiment is different from the first embodiment in that a degree of certainty that each of the A∩B documents includes a description on both the product A and the product B is given to the A∩B document, and that the appearance frequency of each of the words is calculated using the degree of certainty of the document including the word.

Next, details of processing procedures of the information presentation device of the present embodiment that are different from those in the first embodiment will be described.

First, a processing procedure of the A document group extraction unit 71 will be described. The object of the process of the A document group extraction unit 71 is to find out all the A documents from the labeled document DB 300.

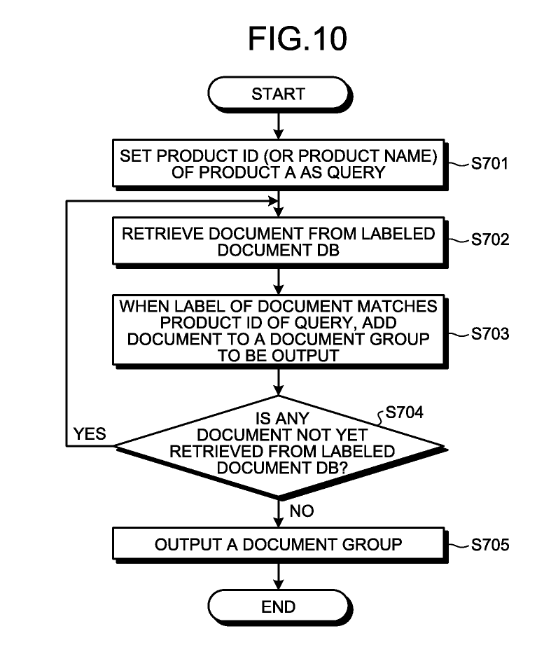

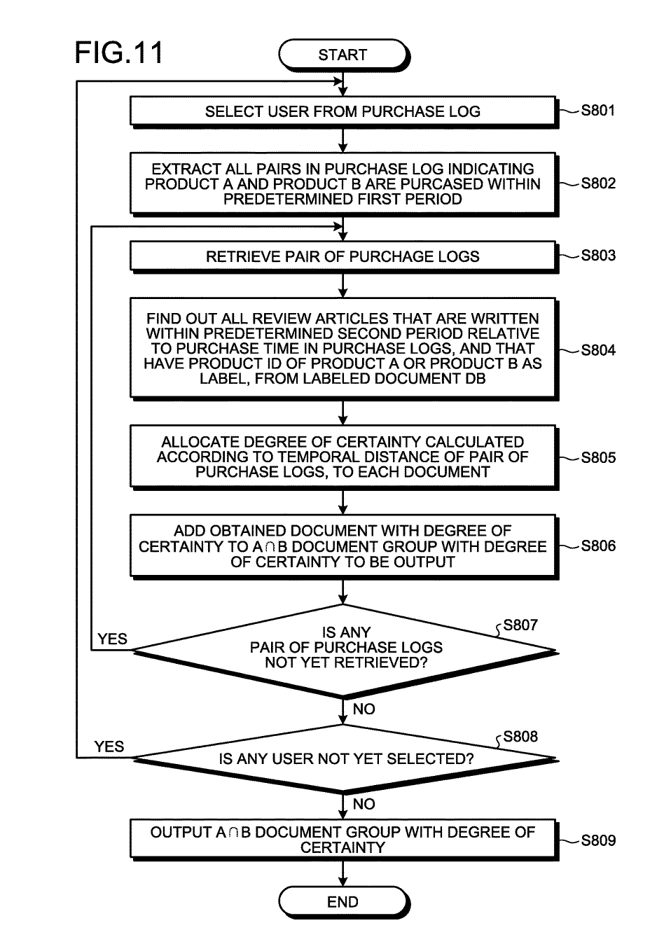

FIG. 10 is a flow chart illustrating the processing procedure of the A document group extraction unit 71. First, the A document group extraction unit 71 retrieves the product ID of the product A from the metadata relating to the product A, and sets the product ID of the product A as a query to search (step S701).

Next, the A document group extraction unit 71 retrieves a document from the labeled document DB 300 (step S702). The A document group extraction unit 71 then determines whether the label of the document retrieved at step S701 matches the product ID of the query. When the label of the document is matched with the product ID, the A document group extraction unit 71 adds the document to the A document group 15 to be output (step S703).

Next, the A document group extraction unit 71 determines whether there is any document not yet retrieved from the labeled document DB 300 (step S704). When there is a document not yet retrieved from the labeled document DB 300 (Yes at step S704), the A document group extraction unit 71 returns the process to step S702 and repeats the following processes. On the other hand, when the processes at step S702 and S703 are performed on all the documents in the labeled document DB 300 (No at step S704), the A document group extraction unit 71 outputs the A document group 15 (step S705), and finishes the series of processes.

The object of the process of the B document group extraction unit 81 is to find out all the B documents from the labeled document DB 300. The process of the B document group extraction unit 81 is the same as the process of the A document group extraction unit 71 described above, except that the query used for searching is replaced with the product ID of the product B, and the document group to be output is replaced with the B document group 25. Thus, the detailed description thereof will be omitted.

Next, a processing procedure of the A∩B document group extraction unit 91 will be described. The object of the process of the A∩B document group extraction unit 91 is to find out the A∩B document from the labeled document DB 300. Because each of the labeled documents in the labeled document DB 300 is only associated with a single product ID, it is not possible to determined whether the labeled document includes a description on both the product A and the product B only from the metadata. In this example, the viewpoint is changed, and it is assumed that the user who has purchased the product A and the product B at the same time or at close timings has an intention to the combination of the two products, and there is a high possibility that the review document written by the user at the timing close to the time of purchase includes a description on the combination of the products. Consequently, in the present embodiment, a user who matches this assumption is selected using the purchase log 400, and a review article that matches this assumption is extracted from the review articles written by the user, as the A∩B document. Moreover, the A∩B document group with the degree of certainty 95 is obtained by giving the degree of certainty that a description on both the product A and the product B is included, to the A∩B document group extracted in this manner.

FIG. 11 is a flow chart illustrating a processing procedure of the A∩B document group extraction unit 91. First, the A∩B document group extraction unit 91 selects a user from the purchase log 400 (step S801).

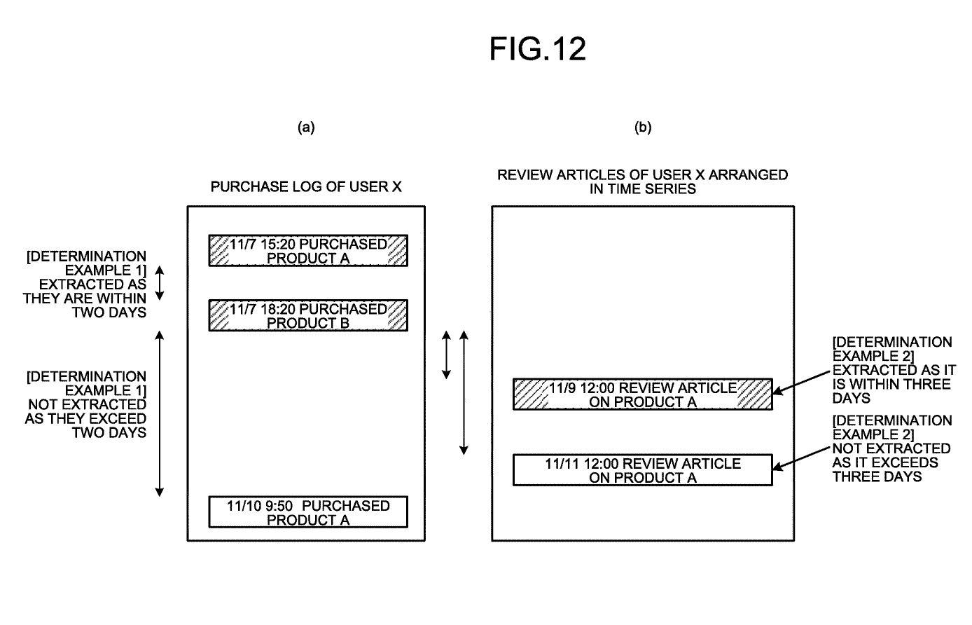

Next, the A∩B document group extraction unit 91 extracts all pairs of purchase logs indicating that the user who is selected at step S801 has purchased the product A and the product B within a predetermined first period (step S802). FIG. 12 illustrates the determination example of the process at (a). When the first period described above is set to two days, as illustrated in the determination example 1 at (a) in FIG. 12, a pair of “November 7^{th} 15:20 purchased product A” and “November 7^{th} 18:20 purchased product B” in the purchase logs of a user X are extracted in the process at step S802, because the time difference of purchasing the products is within two days or less. On the other hand, a pair of “November 7^{th} 18:20 purchased product B” and “November 10^{th} 9:50 purchased product A” are not extracted in the process at step S802, because the time difference of purchasing the products exceeds two days. In the following, difference in purchase times in a pair of purchase logs is referred to as a “purchase time difference”.

Next, the A∩B document group extraction unit 91 retrieves a pair of purchase logs extracted at step S802 (step S803). The A∩B document group extraction unit 91 then retrieves all documents (review articles) that are written by the user selected at step S801 within a predetermined second period from the later purchase time between the purchase times indicated in the pair of purchase logs retrieved at step S803, and that each have the product ID of the product A or the product B as the label, from the labeled document DB 300 (step S804).

FIG. 12 illustrates the determination example of the process at (b). As illustrated in the determination example 2 at (b) in FIG. 12, when the second period described above is set to three days, “November 9^{th} 12:00 review article on product A” in the review articles written by the user X, is the review article written within three days or less from the purchase time in the purchase log of “November 7^{th} 18:20 purchased product B”. Thus, this review article is retrieved in the process at step S804. On the other hand, “November 11^{th} 12:00 review article on product A” is the review article written after three days have passed since the purchase time in the purchase log of “November 7^{th} 18:20 purchased product B”. Thus, this review article is not retrieved in the process at step S804. In the following, difference in times between the purchase time in the purchase log and the review written time is referred to as “review time difference”.

Next, the A∩B document group extraction unit 91 allocates the degree of certainty according to the purchase time difference of the pair of purchase logs retrieved at step S803, to each of the documents retrieved at step S804 (step S805). For example, the value of the degree of certainty decreases with an increase in the purchase time difference such as the degree of certainty is 100% when the pair of purchase logs indicate that the products are purchased in the same session, the degree of certainty is 90% when the pair of purchase logs indicate that the products are purchased within an hour or less, the degree of certainty is 80% when the pair of purchase logs indicate that the products are purchased within two hours or less, and the degree of certainty is 50% when the pair of purchase logs indicate that the products are purchased on the same day. In the present embodiment, the degree of certainty according to the purchase time difference of the pair of purchase logs that caused the document to be retrieved, is applied to the document retrieved from the labeled document DB 300. However, a method of giving the degree of certainty is not limited thereto. For example, the document retrieved from the labeled document DB 300 may be given the degree of certainty whose value decreases with an increase in the review time difference. Also, the document retrieved from the labeled document DB 300 may be given the degree of certainty in which the purchase time difference and the review time difference are both taken into consideration.

Next, the A∩B document group extraction unit 91 adds the document with the degree of certainty that is obtained in the process at step S805 to the A∩B document group with the degree of certainty 95 to be output (step S806).

Next, the A∩B document group extraction unit 91 determines whether there is any pair of purchase logs not yet retrieved at step S803 (step S807). When there is a pair of purchase logs not yet retrieved (Yes at step S807), the A∩B document group extraction unit 91 returns the process to step S803 and repeats the following processes. On the other hand, when the processes from step S803 to step S806 are performed on all the pairs in the purchase log (No at step S807), the A∩B document group extraction unit 91 determines whether there is any user not yet selected at step S801 (step S808). When there is a user who is not yet selected (Yes at step S808), the A∩B document group extraction unit 91 returns the process to step S801 and repeats the following processes.

On the other hand, when all the users included in the purchase log are selected and the processes from step S802 to step S806 are performed (No at step S808), the A∩B document group extraction unit 91 outputs the A∩B document group with the degree of certainty 95 (step S809), and finishes the series of processes.

Next, a processing procedure of the word relation degree evaluation unit 92 will be described. Similar to that of the word relation degree evaluation unit 32 of the first embodiment, the object of the process of the word relation degree evaluation unit 92 is to calculate the third score indicating a relation with both the product A and the product B, for each of the words included in the A∩B document group with the degree of certainty 95. However, the word relation degree evaluation unit 92 is different from the word relation degree evaluation unit 32 of the first embodiment in that the degree of certainty is given to the A∩B document.

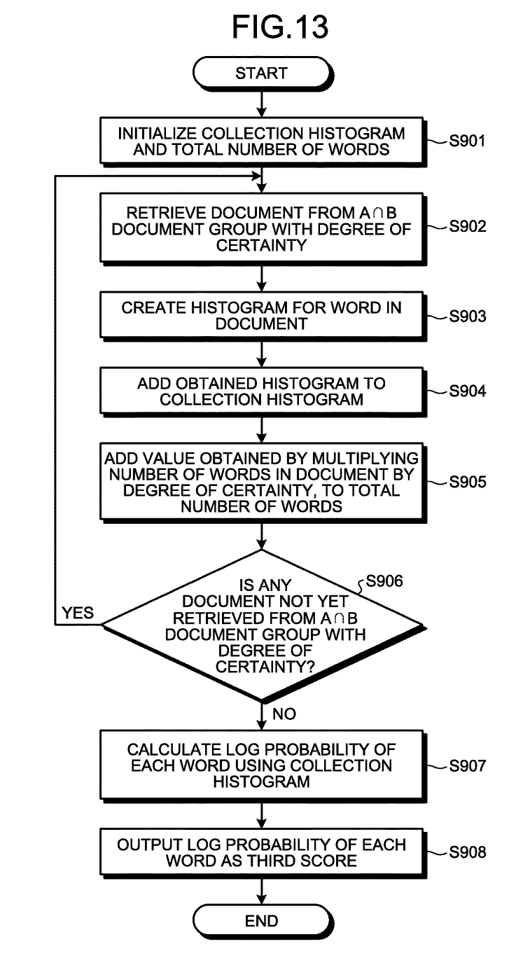

FIG. 13 is a flow chart illustrating a processing procedure of the word relation degree evaluation unit 92. First, the word relation degree evaluation unit 92 initializes the collection histogram for collecting the appearance frequency of each of the words and the total number of words (step S901). The total number of words is a value obtained by adjusting the total number of words included in the A∩B document group with the degree of certainty 95 according to the degree of certainty of the document, as will be described below.

The word relation degree evaluation unit 92 retrieves a document from the A∩B document group with the degree of certainty 95 (step S902). The word relation degree evaluation unit 92 then creates a histogram for words included in the document retrieved at step S902 (step S903). However, the appearance frequency given to each of the words is obtained by multiplying the actual appearance frequency by the degree of certainty. For example, when it is assumed that a word A has appeared ten times, a word B has appeared six times, and a word C has appeared four times in the document with the degree of certainty of 50%, the appearance frequency of the word A is five times, the appearance frequency of the word B is three times, and the appearance frequency of the word C is two times.

Next, the word relation degree evaluation unit 92 adds the histogram obtained at step S903 to the collection histogram (step S904). The word relation degree evaluation unit 92 also adds the value obtained by multiplying the number of words in the document by the degree of certainty, to the total number of words (step S905). For example, when the number of words in the document is 1,000 and the degree of certainty is 50%, the number of words to be added is 500.

Next, the word relation degree evaluation unit 92 determines whether there is any document not yet retrieved from the A∩B document group with the degree of certainty 95 (step S906). When there is a document not yet retrieved from the A∩B document group with the degree of certainty 95 (Yes at step S906), the word relation degree evaluation unit 92 returns the process to step S902 and repeats the following processes. On the other hand, when the processes from step S902 to step S905 are performed on all the documents in the A∩B document group with the degree of certainty 95 (No at step S906), the word relation degree evaluation unit 92 calculates the log probability of each of the words using the collection histogram (step S907). More specifically, when the appearance frequency of each of the words indicated by the collection histogram is x, the total number of words in the A∩B document group with the degree of certainty 95 (total number of words added at step S905) is y, the log probability is log(x/y). The word relation degree evaluation unit 92 then outputs the log probability of each of the words calculated at step S907 as the third score of each of the words (step S908), and finishes the series of processes.

When a processing method based on the degree of certainty according to the purchase time difference or the review time difference described above is used in the word relation degree evaluation unit 92, a threshold process using the first period and the second period does not need to be performed, when the A∩B document group is to be extracted by the A∩B document group extraction unit 91. This is because, even if a review article with a very large purchase time difference or review time difference is extracted when the threshold process is not performed in the A∩B document group extraction unit 91, such a review article is given a very small degree of certainty. When the threshold process is not performed, review articles to be extracted increases in number, and thus the calculation amount increases. However, it is possible to prevent a review article from being missed of retrieve in the threshold process.

The other processes of the information presentation device of the present embodiment are the same as those in the first embodiment described above. In other words, in the information presentation device of the present embodiment, the total score calculation unit 50 calculates the total score of each of the words included in the A∩B document group with the degree of certainty 95, the unique word output unit 61 outputs the important word with higher total score on the screen 200 as the word-based recommendation reason 65, and unique sentence output unit 62 outputs the sentence with many important words on the screen 200 as the sentence-based recommendation reason 66.

Consequently, by using the information presentation device of the present embodiment, it is possible to suitably present the recommendation reason including information on the combined effect of the product A and the product B, to the user who is using the EC system, and improve the sales promotion effects by the collaborative recommendation. In other words, the user who is using the EC system is motivated to purchase the product B and can easily purchase the product accompanied by new experiences, by referring to the recommendation reason presented by the information presentation device of the present embodiment. Consequently, shops can increase sales opportunities.

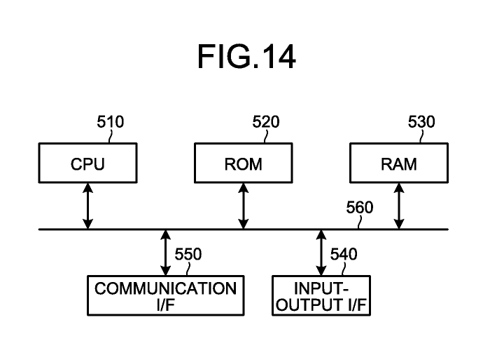

For example, the above functions in the information presentation device of the first embodiment or the second embodiment described above can be implemented when a predetermined computer program is executed in the information presentation device. In this case, for example, as illustrated in FIG. 14, the information presentation device may have a hardware configuration using a normal computer provided with a processor such as a central processing unit (CPU) 510, a storage device such as a read only memory (ROM) 520 and a random access memory (RAM) 530, an input-output interface (I/F) 540 to which a display unit and various operation devices are connected, a communication I/F 550 that performs communication by connecting to a network, a bus 560 that connects the units, and the like.

For example, the computer program executed by the information presentation device described above is provided as a computer program product by being recorded on a computer readable recording medium such as a compact disc-read only memory (CD-ROM), a flexible disk (FD), a compact disc recordable (CD-R), a digital versatile disc (DVD), and the like in an installable or executable file format.

Moreover, the computer program executed by the information presentation device described above may be stored on a computer connected to a network such as the Internet, and provided by being downloaded via the network. The computer program executed by the information presentation device of the present embodiment may also be provided or distributed via a network such as the Internet.

Furthermore, the computer program executed by the information presentation device described above may be incorporated into the ROM 520 and the like in advance.

The computer program executed by the information presentation device described above has a modular configuration including the processing units (first score calculation units 10 and 70, the second score calculation units 20 and 80, the third score calculation units 30 and 90, the fourth score calculation unit 40, the total score calculation unit 50, and the presentation unit 60) of the information presentation device. As actual hardware, for example, the above processing units are loaded on the RAM 530 (main storage), and the above processing units are generated on the RAM 530 (main storage), when the CPU 510 (processor) reads out the computer program from the above storage medium and executes the computer program. Moreover, in the information presentation device of the embodiment, a part or all of the above processing units may be implemented using dedicated hardware such as an application specific integrated circuit (ASIC) and a field-programmable gate array (FPGA).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information presentation device that presents a recommendation reason including information on a combined effect of a first product and a second product, when recommending the second product that goes well with the first product a user is referring to, the device comprising:
a first score calculation unit configured to extract a first group of documents relating to the first product from a group of documents to be searched, and calculate a first score indicating a relation with the first product, for each word included in the first group of documents;
a second score calculation unit configured to extract a second group of documents relating to the second product from the group of documents to be searched, and calculate a second score indicating a relation with the second product, for each word included in the second group of documents;
a third score calculation unit configured to extract a third group of documents relating to both the first product and the second product from the group of documents to be searched, and calculate a third score indicating a relation with both the first product and the second product, for each word included in the third group of documents;
a total score calculation unit configured to subtract the first score and the second score from the third score, to calculate a total score for each word included in the third group of documents; and
a presentation unit configured to present at least one of one or more important words that are selected according to a predetermined criterion based on the total score, and one or more pieces of text including important words in the third group of documents, as the recommendation reason.

2. The device according to claim 1, wherein
the first score calculation unit extracts the first group of documents including a description representing the first product from the group of documents to be searched, and calculates, for each word included in the first group of documents, the first score having a value that increases with an increase in an appearance frequency of the word in the first group of documents,
the second score calculation unit extracts the second group of documents including a description representing the second product from the group of documents to be searched, and calculates, for each word included in the second group of documents, the second score having a value that increases with an increase in an appearance frequency of the word in the second group of documents, and
the third score calculation unit extracts the third group of documents including a description representing the first document as well as a description representing the second document from the group of documents to be searched, and calculates, for each word included in the third group of documents, the third score having a value that increases with an increase in an appearance frequency of the word in the third group of documents.

3. The device according to claim 2, further comprising:
a fourth score calculation unit configured to calculate, for each word included in the group of documents to be searched, a fourth score having a value that increases with a decrease in an appearance frequency of a document including the word in the group of documents to be searched, wherein
the total score calculation unit further multiplies or adds the fourth score and a value obtained by subtracting the first score and the second score from the third score, to calculate the total score for each word included in the third group of documents.

4. The device according to claim 1, wherein
the group of documents to be searched is a group of documents associated with identification information of products,
the first score calculation unit extracts the first group of documents associated with identification information of the first product from the group of documents to be searched, and calculates, for each word included in the first group of documents, the first score having a value that increases with an increase in an appearance frequency of the word in the first group of documents,
the second score calculation unit extracts the second group of documents associated with identification information of the second product from the group of documents to be searched, and calculates, for each word included in the second group of documents, the second score having a value that increases with an increase in an appearance frequency of the word in the second group of documents, and
the third score calculation unit extracts the third group of documents that are written by a user who has purchased both the first product and the second product, and are associated with the identification information of the first product or the identification information of the second product, from the group of documents to be searched, and calculates, for each word included in the third group of documents, the third score having a value that increases with an increase in an appearance frequency of the word in the third group of documents.

5. The device according to claim 4, wherein the third score calculation unit extracts, from the group of documents to be searched, the third group of documents that are written by the user who has purchased both the first product and the second product within a predetermined first period, within a predetermined second period after the user has purchased the first product or the second product, and are associated with the identification information of the first product or the identification information of the second product, and calculates, for each word included in the third group of documents, the third score having a value that increases with an increase in an appearance frequency of the word in the third document.

6. The device according to claim 4, wherein the third score calculation unit sets, for each document included in the third group of documents, a degree of certainty that the document includes a description on both the first product and the second product, based on a purchase time difference between the first product and the second product, or a time difference between when the first product or the second product is purchased and when the document is written, and multiplies or adds, for each word included in the third group of documents, a score set for a document including the word, and a score according to an appearance frequency of the word in the third group of documents, to calculate the third score.

7. An information presentation method that is executed by an information presentation device that presents a recommendation reason including information on a combined effect of a first product and a second product, when recommending the second product that goes well with the first product a user is referring to, the information presentation method comprising:
extracting a first group of documents relating to the first product from a group of documents to be searched, and calculating a first score indicating a relation with the first product, for each word included in the first group of documents, using the information presentation device;
extracting a second group of documents relating to the second product from the group of documents to be searched, and calculating a second score indicating a relation with the second product, for each word included in the second group of documents, using the information presentation device;
extracting a third group of documents relating to the first product and the second product from the group of documents to be searched, and calculating a third score indicating a relation with both the first product and the second product, for each word included in the third group of documents, using the information presentation device;
subtracting the first score and the second score from the third score, to calculate a total score for each word included in the third group of documents, using the information presentation device; and
presenting at least one of one or more important words selected according to a predetermined criterion based on the total score, and one or more pieces of text including important words in the third group of documents, as the recommendation reason, using the information presentation device.

8. A computer program product comprising a non-transitory computer-readable medium including programmed instructions, the instructions causing a computer to execute:
extracting a first group of documents relating to a first product from a group of documents to be searched, and calculating a first score indicating a relation with the first product, for each word included in the first group of documents;
extracting a second group of documents relating to a second product from the group of documents to be searched, and calculating a second score indicating a relation with the second product, for each word included in the second group of documents;
extracting a third group of documents relating to the first product and the second product from the group of documents to be searched, and calculating a third score indicating a relation with both the first product and the second product, for each word included in the third group of documents;
subtracting the first score and the second score from the third score, to calculate a total score for each word included in the third group of documents; and
presenting at least one of one or more important words selected according to a predetermined criterion based on the total score, and one or more pieces of text including important words in the third group of documents, as a recommendation reason including information on a combined effect of the first product and the second product.
